(19) United States
(12) Patent Application Publication
(10) Pub. No.: US 2020/0077190 A1
(43) Pub. Date: Mar. 5, 2020

(54) Earbuds With Vocal Frequency-Based Equalization

(71) Applicant: Soniphi LLC, Incline Village, NV (US)

(72) Inventors: Deric Solis, Santa Rosa, CA (US); Matthew Sanderson, Incline Village, NV (US); James McClanahan, Greenwood Village, CO (US); Wayne J. Powell, Centennial, CO (US)

(21) Appl. No.: 16/553,391

(22) Filed: Aug. 28, 2019

Related U.S. Application Data
(60) Provisional application No. 62/724,556, filed on Aug. 29, 2018.

(51) Int. Cl. H04R 3/04; H04R 1/10; G10L 25/51

(52) U.S. Cl. CPC H04R 3/04; G10L 25/51; H04R 1/1041; H04R 1/1016

(57) ABSTRACT

Systems and methods are provided in which characteristics of a user's voice are utilized to record and to generate a user-specific audio filter. The user-specific audio filter is applied to stored audio files to generate modified audio files that enhance the user's listening experience. In a preferred embodiment the system utilizes a portable audio player and a pair of earbuds.

This application claims the benefit of U.S. Provisional Patent Application No. 62/724,556 filed on Aug. 29, 2018. These and all other referenced extrinsic materials are incorporated herein by reference in their entirety. Where a definition or use of a term in a reference that is incorporated by reference is inconsistent or contrary to the definition of that term provided herein, the definition of that term provided herein is deemed to be controlling.

### FIELD OF THE INVENTION

The field of the invention is audio control systems, particularly for headphones and earbuds.

### BACKGROUND

The following description includes information that may be useful in understanding the present invention. It is not an admission that any of the information provided herein is prior art or relevant to the presently claimed invention, or that any publication specifically or implicitly referenced is prior art.

Conventional portable audio systems typically include a pair of headphones or earbuds, which connect to a portable media player (either through a wired connection or wirelessly). As the headphone industry has expanded, the style range of headphones from which a user may choose has increased. One popular style or configuration of headphones is known as “earbud-style” headphones (e.g., headphones designed to fit within a user's ear). Earbud-style headphones are popular among users because earbud headphones are generally small and portable. Moreover, when a user is participating in various activities, earbud headphones may cooperate better with the user's other accessories or equipment, such as glasses, helmets, ski goggles, ear protectors, beanies, and headbands.

With the increasing popularity of earbuds and the increase in advanced audio functionality available to current devices, the corresponding benefits of using the advanced audio functionality to improve the audio characteristics of earbuds have yet to be fully realized. In particular, there is considerable potential for earbud performance to be enhanced for a specific user by adjusting the frequency distribution of outputted audio files. This is typically performed by either manual adjustment via software that emulates an audio equalizer or by selection from a set of predetermined audio settings. Such predetermined settings, however, may not provide a sufficient range of choices for all users. Similarly, manual adjustment is time consuming and may not be suitable for all users.

Attempts have been made to address these issues by adjusting audio settings based on data provided by the headset. For example, U.S. Pat. No. 10,299,029, to Aase, describes a system in which data from earbud pressure sensors are used to determine the size and shape of a user's ear, which are in turn used to adjust volume levels within different frequency ranges for a particular user. Similarly, U.S. Pat. No. 10,334,347, to Kofman and Klemme, describes a system in which data from a capacitance-based sensor is used to determine position of an earbud within the ear to adjust audio output of the earbud. Such approaches, however, cannot take into account subjective hearing differences due to damage to the middle ear, inner ear, or portions of the brain utilized for audio processing.

All publications identified herein are incorporated by reference to the same extent as if each individual publication or patent application were specifically and individually indicated to be incorporated by reference. Where a definition or use of a term in an incorporated reference is inconsistent or contrary to the definition of that term provided herein, the definition of that term provided herein applies and the definition of that term in the reference does not apply.

Further improvements to earbud systems are, therefore, desirable. Thus, there is still a need in the art for improved functionality based on gathered user data for earbuds.

### SUMMARY OF THE INVENTION

The inventive subject matter provides apparatus, systems and methods in which vocal data collected from a user is utilized to generate a user-specific audio filter that reflects characteristics of the user's hearing. This user-specific audio filter is then utilized to modify existing audio files, generating audio files that are customized to improve the user's listening experience.

One embodiment of the inventive concept is a method for enhancing audio quality of earbuds by receiving and recording a voice communication from a user, transforming the voice communication into vocal data using a Fast Fourier Transform analysis and/or Fractal analysis, determining a unique vocal feature associated with the user to create a user specific audio profile from the vocal data; and creating a user specific audio configuration for the user associated with the user specific audio profile. In some embodiments the method can also modify a stored audio file using the user specific audio profile to generate a user customized audio file. In some embodiments this process can be repeated using a second voice communication from the user to generate a set of updated vocal features, which are in turn used to update or replace an earlier generated audio profile. This updated audio profile can be used to generate a new or improved modified audio file.

Another embodiment of the inventive concept is a personal audio system that includes an earbud having a microphone and a speaker (where the microphone is positioned to receive vocal sounds from a user), a first audio processor that is in communication with the microphone and that has stored instructions for performing a Fourier Transform analysis and/or Fractal analysis on vocal data received from the microphone to generate a user specific audio profile from the vocal data, a first database that is in communication with the first audio processor and that includes the user specific audio profile, and a second audio processor that includes stored instructions for modifying an audio file using the user specific audio profile to generate a user customized audio file, wherein the second audio process is communicatively coupled to the speaker. In some embodiments the earbud includes the first audio processor. In such embodiments the second audio processor can be positioned in an audio player that is distinct from but is communication with the earbud. Such an audio player can include a second database that includes one or more audio files.

Various objects, features, aspects and advantages of the inventive subject matter will become more apparent from the following detailed description of preferred embodiments, along with the accompanying drawing figures in which like numerals represent like components.

### BRIEF DESCRIPTION OF THE DRAWINGS

FIG. 1 is a schematic of a method analyzing a voice recording and creating a unique audio profile.

FIG. 2 schematically depicts a system of the inventive concept.

### DETAILED DESCRIPTION

The inventive subject matter provides apparatus, systems, and methods for analyzing a voice recording and creating a unique audio profile. This audio profile can be used to modify an existing audio file and enhance the user's listening experience.

Groupings of alternative elements or embodiments of the invention disclosed herein are not to be construed as limitations. Each group member can be referred to and claimed individually or in any combination with other members of the group or other elements found herein. One or more members of a group can be included in, or deleted from, a group for reasons of convenience and/or patentability. When any such inclusion or deletion occurs, the specification is herein deemed to contain the group as modified thus fulfilling the written description of all Markush groups used in the appended claims.

One should appreciate that systems and methods of the inventive concept generate and utilize an individualized audio pre-set or filter that enhances the listening experience of a user without the need for extraneous audio measurements.

The following discussion provides many example embodiments of the inventive subject matter. Although each embodiment represents a single combination of inventive elements, the inventive subject matter is considered to include all possible combinations of the disclosed elements. Thus, if one embodiment comprises elements A, B, and C, and a second embodiment comprises elements B and D, then the inventive subject matter is also considered to include other remaining combinations of A, B, C, or D, even if not explicitly disclosed.

As used herein, and unless the context dictates otherwise, the term “coupled to” is intended to include both direct coupling (in which two elements that are coupled to each other contact each other) and indirect coupling (in which at least one additional element is located between the two elements). Therefore, the terms “coupled to” and “coupled with” are used synonymously.

Recent research has found that a user's voice can only emit sounds which the user's ear can register. As voice and hearing are intrinsically linked via the nervous system, Inventors believe that the vocal characteristics can be used as data that can be applied to determine audio spectrum hearing capabilities of a person. In embodiments of the inventive concept vocal data is used to create an enhanced audio environment for a user, through by analysis of frequency data obtained from the user's voice and generation of a unique audio filter that matches the outlier frequency ranges found in the vocal analysis.

In some embodiments, a voice frequency-based equalization system transforms the user's voice via Fast Fourier Transform (FFT) and/or Fractal analysis to determine unique vocal features which indicate a user's unique hearing profile. However, it is contemplated that any type of analysis known in the art can be employed to analyze a voice. Based on one or more analyses, the present invention contemplated creates a preset audio configuration for a user that enhances the sound and overall audio experience of the user.

In preferred embodiments, the preset audio configuration is loaded onto a storage device (such as an audio player) coupled to an earbud, speaker, and/or headset, and is time stamped as a unique filter for that user at the time of recording. As such, all audio played on the earbuds, the speaker, or the headset can be filtered by this filter for the enhancement of the audio to cater to the user's unique hearing and vocal profile. It is contemplated that the user can at any time re-record, and the preset will change according to the most recent FFT analysis.

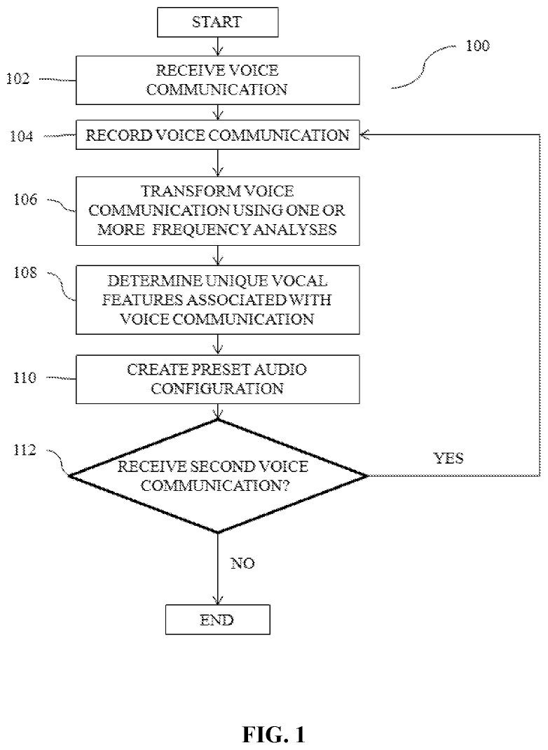

An example of a method of the inventive concept (100) is shown schematically in FIG. 1. As shown, a voice communication and/or vocal data is initially received from a user (102), for example from a microphone or similar device. This vocal communication and/or data is recorded (for example, by storage in a suitable digital database). The recorded vocal data is analyzed to determine a frequency distribution (106). For example, vocal data can be subjected to Fourier Transform analysis and/or Fractal analysis in order to identify a frequency distribution of the recorded vocal data (for example, by identifying peaks and/or troughs in frequency intensity, identifying deviations from a stored default frequency distribution, etc.), which in turn permits determination of vocal features characteristic of and/or unique to the user (108). The determined frequency distribution and/or characteristics vocal features can be stored in an appropriate database, and made available to a processor.

The characteristic and/or unique vocal features can be used by a processor to generate a preset audio configuration (110) that can act as an audio filter. For example, if the user's vocal data indicates a hearing loss within a particular frequency range the preset audio configuration can act as an audio filter that increases speaker output within that frequency range. Alternatively, if the user's characteristic and/or unique vocal features indicate a substantial loss of hearing within one or more frequency ranges the preset audio configuration can act as an audio filter that compresses or redistributes the output of an audio file to preferentially fall within an audio range that is readily perceived by the user.

In some embodiments a user may elect to repeat the process, generating a second voice command and/or vocal data set that is similarly processed (112). In such an embodiment the second voice command and/or vocal data set can be used to generate a new preset audio configuration that replaces one generated earlier. In other embodiments the second voice command and/or vocal data set can be used to modify and earlier preset audio configuration in order to provide a more sophisticated or accurate audio filter.

An earbud of the inventive concept can include a housing or body that is in contact with and/or at least partially inserted into an ear of a user when in use. Such a housing can be constructed of one or more materials suitable for contact with human skin, and can have different compositions in different regions of the housing. For example, portions of the housing that are exposed when in use can be constructed of one or more rigid materials (e.g. hard plastic, metal, ceramic, etc.) whereas portions that are inserted into the ear canal can be constructed of one or more pliant materials (e.g. silicone rubber, latex, polyurethane, etc.). In some embodiments an earbud of the inventive concept can include a hook or similar projection that engages with the concha of the ear, improving stability and proper positioning of the earbud. The housing of the earbud can also support one or more control features that can be used to control earbud functions. In a preferred embodiment a portion of the body or housing can extend downwards in a stem or stalk.

Such an earbud can include a power supply (such as a battery) and one or more speakers, and is in communication with a source of audio and/or video files for playback through the earbud. Such audio and/or video files can be stored on memory within the earbud, or can be stored on memory in an external device (such as a computer, telephone, or portable audio player). In embodiments where audio and/or video files are stored in an external device the earbud can include an antenna, circuitry, and appropriate processing to support wireless communication (e.g. BlueTooth, WiFi, etc.). Alternatively or in addition to such wireless circuitry, and earbud of the inventive concept can include a port that supports a wired connection. Earbuds of the inventive concept can also include an antenna and associated circuitry to support wireless charging of an onboard power supply, for example by magnetic induction.

In preferred embodiments, the earbuds comprise a main body portion with an extended curvature configuration. In one example, the earbuds include a speaker housing separated into a divided group of isobaric sound chambers and an extension that couples the isobaric sound chambers via a transmission line to form a waveguide between the speaker housing and the extension.

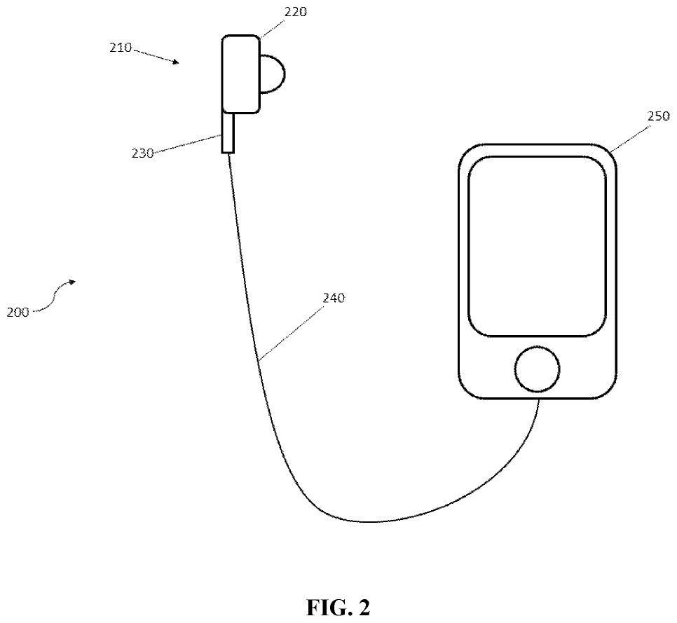

An example of a system of the inventive concept (200) is shown in FIG. 2. As shown the system includes an earbud (210) or headphone component that is positioned at or within the ear of a user. Such earbud can include a housing (220), which can enclose one or more speakers. In some embodiments the housing can also enclose or define one or more resonating or isobaric chambers that aid in acoustic performance. The housing can also include a stem (230) or similar extension. Such a stem can include a microphone, the microphone being positioned for receiving vocal sounds from a user when the earbud is in use. In other embodiments the microphone can be included in or on the portion of the body that encloses the speaker and/or a resonating chamber.

The earbud (210) can be connected to an audio player (250), for example using a cable (240). In some embodiments connections to the audio player can be accomplished using a wireless technology, (e.g, BlueTooth, WiFi, etc.). The audio player (250) provides storage for audio files, and can incorporate one or more processors utilized to process vocal data received from the microphone and to generate audio files that are modified based on the vocal data. The audio player (250) can also include storage for one or more databank(s) for storing vocal data, instructions for utilizing vocal data to generate an audio filter and/or application of such an audio filter to generate modified audio file, and/or modified audio files.

While such features and functions can be incorporated into an audio player, it should be appreciated that one more of such features and functions can be incorporated into an earbud, a pair of earbuds, and/or a headset. For example, and earbud of the system can include a processor that is in communication with the microphone and is used to analyze vocal data. In such an embodiment the audio player can include a second processor that utilizes the results of such analysis to generate modified audio files.

In other embodiments, all processing occurs within an earbud, pair of earbuds, and/or headphones, and the portable audio player is essentially used for storage of unmodified and/or modified audio files. In such embodiments the earbud, pair of earbuds, and/or headset can be utilized between two or more audio players. Such audio player can be generic and not include system-specific components, essentially providing only storage and transmission of audio files. Alternatively, in some embodiments all of the components for the system can be incorporated into the earbud, pair of earbuds, and/or headset; such a system may not include a separate and distinct audio player.

It should be apparent to those skilled in the art that many more modifications besides those already described are possible without departing from the inventive concepts herein. The inventive subject matter, therefore, is not to be restricted except in the spirit of the appended claims. Moreover, in interpreting both the specification and the claims, all terms should be interpreted in the broadest possible manner consistent with the context. In particular, the terms “comprises” and “comprising” should be interpreted as referring to elements, components, or steps in a non-exclusive manner, indicating that the referenced elements, components, or steps may be present, or utilized, or combined with other elements, components, or steps that are not expressly referenced. Where the specification claims refer to at least one of something selected from the group consisting of A, B, C . . . and N, the text should be interpreted as requiring only one element from the group, not A plus N, or B plus N, etc.

What is claimed is:

1. A method for enhancing audio quality of earbuds, comprising:
receiving a voice communication from a user;
recording the voice communication from the user;
transforming the voice communication into first vocal data using at least one of Fast Fourier Transform analysis and Fractal analysis;
determining a unique vocal feature associated with the user to create a user specific audio profile from the first vocal data; and
creating a user specific audio configuration for the user associated with the user specific audio profile.

2. The method of claim 1, comprising modifying a stored audio file using the user specific audio profile to generate a first user customized audio file.

3. The method of claim 1, further comprising:
receiving a second voice communication from the user;
recording the second voice communication from the user;
transforming the second voice communication into second vocal data using at least one of Fast Fourier Transform analysis and Fractal Analysis; and
determining updated vocal features associated with the user to create an update to the user specific audio profile.

4. The method of claim 3, further comprising updating the user specific audio configuration based on the update to generate an updated user specific audio profile.

5. The method of claim 4, comprising modifying a stored audio file using the updated user specific audio profile to generate a second user customized audio file.

6. A personal audio system, comprising:
an earbud comprising a microphone and a speaker, wherein the microphone is positioned to receive vocal sounds from a user;
a first audio processor communicatively coupled the microphone, and comprising stored instructions for performing at least one of Fourier Transform analysis and Fractal analysis on vocal data received from the microphone to generate a user specific audio profile from the vocal data;
a first database communicatively coupled to the first audio processor and comprising the user specific audio profile;
a second audio processor communicatively comprising stored instructions for modifying an audio file using the user specific audio profile to generate a user customized audio file, wherein the second audio process is communicatively coupled to the speaker.

7. The system of claim 6, wherein the earbud comprises the first audio processor.

8. The system of claim 6, wherein the second audio processor is positioned in an audio player that is distinct from the earbud, wherein the audio player is in electronic communication with the earbud.

9. The system of claim 8, wherein the audio player comprises a second database, wherein the second database comprises the audio file.
